(19) United States
(12) Patent Application Publication
(10) Pub. No.: US 2009/0148765 A1
(43) Pub. Date: Jun. 11, 2009

(54) LITHIUM IRON(II) PHOSPHATE CATHODE ACTIVE MATERIAL

(75) Inventors: WENYU CAO, Shenzhen (CN); SHUIYUAN ZHANG, Shenzhen (CN); NANJIANG LIU, Shenzhen (CN); ZHANFENG JIANG, Shenzhen (CN)

Correspondence Address: GREENBERG TRAURIG, LLP (SV);IP DOCKETING, 2450 COLORADO AVENUE, SUITE 400E, SANTA MONICA, CA, 90404, US

(73) Assignee: BYD COMPANY LIMITED, Shenzhen (CN)

(21) Appl. No.: 12/254,537

(22) Filed: Oct. 20, 2008

(30) Foreign Application Priority Data
Dec. 7, 2007 (CN) 200710199020.6

(51) Int. Cl. H01M 4/58; H01M 2/02

(52) U.S. Cl. 429/163; 429/221

(57) ABSTRACT

Lithium iron(II) phosphate containing cathode active material having lithium iron(II) phosphate particles and nano-carbons and methods of preparation thereof. In addition, the cathode active material includes iron phosphide and can be prepared under an inert atmosphere and sintered at high temperatures. The material mixture includes lithium compound, iron compound, organic carbon, phosphorous and nano-iron particles resulting in an electrode with higher unit capacity and maintenance rate.

### CROSS-REFERENCE TO PRIOR APPLICATIONS

This application claims priority to Chinese Patent Application No. 200710199020.6, filed Dec. 7, 2007.

### FIELD OF THE INVENTION

The embodiments of the present invention relate to batteries, more specifically, to lithium iron(II) phosphate cathode active materials for lithium secondary batteries.

### BACKGROUND

Iron-based compounds are generally low in price, non-toxic, does not absorb moisture, environmentally friendly, heavily abundant storage reserves, and have long life cycles with desirable stability, and so forth. Lithium iron(II) phosphate (LiFePO₄) having olivine structures can produce 3.4 V (Li/Li⁺) of voltage with charge and discharge responses between the LiFePO₄ and FePO₄ phases leading to minimal changes in lattice size, structure and stability. When LiFePO₄ oxidizes to iron phosphate (FePO₄), its volume may decrease by about 6.81%. The shrinkage during the charging process can make up for the expansion of the carbon anode thereby helping to improve the unit volume effectiveness of the lithium-ion battery.

However, the presence of lithium iron(II) phosphate within the battery can lead to decreased electrical conductivity. Thus, in order to enhance electrical conductivity, carbon can often be used as a dopant. Carbon coated LiFePO₄ particles can improve the contact between LiFePO₄ particles thus enhancing the electrochemical properties including charge-discharge capacity and cycling performance. The doping with carbon generally involves mixing smaller molecular weight carbons such as glucose and sucrose with carbon polymer, or acetylene black or conductive carbon black as the source of carbon. The use of carbon polymer may result in incomplete decomposition leaving remnant materials thus decreasing battery performance. If acetylene black or conductive carbon black is used, its molecular density, being larger than the surface area, may lead to uneven distribution thereby lowering a capacitor's maintenance rate. The addition of carbon to lithium iron phosphate can lead to dramatic changes with the additive causing the tap density to decrease thus producing electrode materials with decreased unit volume charge-discharge capacity. Furthermore, after multiple charge and discharge cycles, the lattice structure of LiFePO₄ may undergo changes leading to poor contact between carbon and the LiFePO₄ particles thus lowering the electrochemical properties of the electrode material. In some instances, electronic exchanges cease to occur in certain regions resulting in lower electrode material capacity maintenance rate.

As such, there is a need for a better cathode active material and method of manufacturing the same for lithium-ion batteries with enhanced electrical performance.

### SUMMARY

Accordingly, a first embodiment of the present invention discloses a lithium iron(II) phosphate cathode active material comprising: lithium iron(II) phosphate particles; nano-carbon particles; and iron phosphide, wherein a first portion of the iron phosphide can be disposed about the surfaces of the lithium iron(II) phosphate particles. The first portion of the iron phosphide is about 50 to 80% of the total weight of the iron phosphide in the material. The lithium iron(II) phosphate particles, iron phosphide and nano-carbon particles have molar ratios of 1:(0.001-0.033):(0.066-0.657). The lithium iron(II) phosphate particles have an average particle diameter D50 of about 1 to 7 microns while the nano-carbon particles have an average particle diameter D50 of about 1 to 100 nanometers.

A second embodiment discloses a method of manufacturing a lithium iron(II) phosphate cathode active material under an inert atmosphere, the method comprising: providing a mixture having one or more lithium compounds, iron(II) compounds, organic carbon, phosphorous and nano-iron particles; heating the mixture at a pre-sintering temperature of about 400 to 500° C. for about 6 to 10 hours; and heating the mixture at a sintering temperature of about 650 to 850° C. for about 8 to 30 hours. The mixture has molar ratios of Li:Fe²⁺:Fe:P:C of about 1:(0.9-1.08):(0.01-0.15):(0.9-1.1):(0.1-0.15). The method can further include adding the mixture to a dispersant prior to the heating steps, the dispersant being one or more of acetone, ethanol and methanol. The amount of dispersant can be about 0.5 to 3 times the total weight of the lithium compounds, iron(II) compounds, organic carbon, phosphorous and nano-iron particles within the mixture. In another embodiment, the dispersant can be reclaimed by centrifuge or filtration prior to the heating steps. The nano-iron particles have an average diameter D50 of about 10 to 50 nanometers. The lithium compounds include one or more of lithium carbonate, lithium hydroxide, lithium acid, lithium nitrate and lithium oxalate; the iron(II) compounds include one or more of ferrous oxalate, ferrous chloride and ferrous acid; the phosphorous includes one or more of ammonium phosphate, ammonium hydrogen phosphate and ammonium dihydrogen phosphate; and the organic carbon includes one or more of glucose, sucrose, citric acid, polyvinyl alcohol, polyethylene glycol and starch.

A third embodiment discloses a lithium-ion battery comprising: a battery core; electrolyte; and a battery shell, wherein the battery core and electrolyte are situated within the battery shell, and wherein the battery core includes a cathode electrode, an anode electrode, and a partition between the two electrodes, the cathode electrode having a cathode material comprising: a lithium iron(II) phosphate active material, the active material comprising: lithium iron(II) phosphate particles; nano-carbon particles; and iron phosphide, wherein a first portion of the iron phosphide can be disposed about the surfaces of the lithium iron(II) phosphate particles. The first portion of the iron phosphide is about 50 to 80% of the total weight of the iron phosphide in the material. The lithium iron(II) phosphate particles, iron phosphide and nano-carbon particles have molar ratios of 1:(0.001-0.033):(0.066-0.657). The lithium iron(II) phosphate particles have an average particle diameter D50 of about 1 to 7 microns while the nano-carbon particles have an average particle diameter D50 of about 1 to 100 nanometers. The anode electrode can be a lithium chip or graphite. The battery can further include a conductive agent such as acetylene black and an adhesive such as a mixture of carboxymethyl cellulose (CMC) and polytetrafluoroethylene (PTFE). The electrolyte includes lithium hexafluorophosphate, ethylene carbonate (EC) and diethyl carbonate (DEC).

The presently disclosed embodiments of lithium iron(II) phosphate containing cathode active material includes iron phosphide, which has a greater density than carbon, and can therefore effectively allow one from having to add carbon to the cathode material and lowering the tap density. The presently disclosed lithium iron(II) phosphate containing cathode active materials provide higher tap density than carbon-containing lithium iron(II) phosphate cathode active material by about 20%. As such, the lithium iron(II) phosphate electrode material leads to an increased unit volume capacity of about 20%. Accordingly, the electrode material has higher unit capacity and higher maintenance cycle charge-discharge rate.

Other variations, embodiments and features of the present invention will become evident from the following detailed description, drawings and claims.

### BRIEF DESCRIPTION OF THE DRAWINGS

FIG. 1 illustrates a scanning electron microscope (SEM) image of a lithium iron(II) phosphate cathode active material according to Example 1 of the present invention;

FIG. 2 illustrates an x-ray diffraction (XRD) pattern of the lithium iron phosphate cathode active material of Example 1;

FIG. 3 illustrates the XRD pattern of an insoluble substance of the lithium iron(II) phosphate cathode active material of Example 1 after being dissolved in hydrochloric acid;

FIG. 4 illustrates an XRD pattern of a lithium iron(II) phosphate cathode active material according to Reference 1 of the present invention; and

FIG. 5 illustrates the XRD pattern of an insoluble substance of the lithium iron(II) phosphate cathode active material of Reference 1 after being dissolved in hydrochloric acid.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

The present invention provides a lithium iron(II) phosphate cathode active material having lithium iron(II) phosphate particles, nano-carbons, and iron phosphide. In one embodiment, the molar ratios of lithium iron(II) phosphate particles to nano-carbons can be about 1:0.066-0.657. The lithium iron(II) phosphate particles can have average diameter D50 of about 1 to 7 microns while the nano-carbons can have average diameter D50 of about 10 to 50 nanometers. The iron phosphide can, at least in part, attach to surfaces of the lithium iron(II) phosphate particles, with the total weight of the surface iron phosphide at about 50 to 80% of the total weight of the iron phosphide particles. In one embodiment, the molar ratios of iron phosphide to lithium iron(II) phosphate can be about 0.001-0.033:1.

The lithium iron(II) phosphate cathode active material can be prepared under an inert gas environment such as the likes of argon and/or nitrogen. The mixture can be pre-sintered at about 400 to 500° C. for about 6 to 10 hours, and then subsequently sintered at about 650 to 850° C. for about 8 to 30 hours. The mixture can include lithium compounds, iron(II) compounds, organic carbon, phosphorous, and nano-iron particles. In one embodiment, the mixture can be optimized with molar ratios of Li:Fe²⁺: Fe:P:C of about 1:(0.9-1.08):(0.01-0.15):(0.9-1.1):(0.1-0.15).

The nano-iron particles can have an average particle diameter of about 10 to 50 nanometers with the maximum particle size being less than 90 nanometers. The amount of nano-iron powder to be added to the mixture depends on the amount of iron phosphide generated. In one instance, the nano-iron particle to iron compound Fe:Fe²⁺ has molar ratios of about 0.01-0.16:1.

Sources of lithium compounds include one or more of lithium carbonate, lithium hydroxide, lithium acid, lithium nitrate and lithium oxalate. Iron(II) compounds include one or more of ferrous oxalate, ferrous chloride and ferrous acid. Sources of phosphate include phosphoric acid and/or phosphate salt, more specifically, one or more of ammonium phosphate, ammonium hydrogen phosphate and ammonium dihydrogen phosphate. Carbon includes glucose, sucrose, citric acid, polyvinyl alcohol, polyethylene glycol and starch. The organic compounds can undergo anaerobic decomposition at about 200 to 500° C. to generate high-levels of active nano-carbon particles. At lower temperatures the compounds can have reducing properties at inhibiting the oxidation of the iron and also preventing the formation of larger particles.

The lithium iron(II) phosphate cathode active material includes an intermediary mixture, which can be formed by various means. For example, the mixture can include mixing the lithium compound, iron(II) compound, nano-iron particle, phosphorous and organic carbon in a dispersant. Sources of dispersant include acetone, ethanol and methanol, with the amount of dispersant being 0.5 to 3 times the weight of the combined lithium compound, iron compound, nano-iron particle, phosphorous and organic carbon in the mixture. Subsequently, the mixture can be uniformly mixed in many ways including grinding and polishing for about 5 to 15 hours.

After the lithium compound, iron compound, nano-iron particle, phosphorous and organic carbon have been uniformly mixed in the dispersant, the dispersant can be removed using known methods including centrifuge or filter separation. The removed dispersant can be recycled or reclaimed for environmental reasons or for future use.

The pre-sintering and sintering processes can use a kiln or similar furnace as known by one skilled in the art at a heating rate of 5 to 10° C. per minute. The sintered product can subsequently be removed from the kiln after it had cooled to room temperature also at a cooling rate of 5 to 10° C. per minute.

Additionally, the sintered product can be pulverized or crushed to provide the desired particle sizes for the cathode active material. The pulverization process occurs after the sintered product has been cooled to room temperature. The pulverizing technique includes air current pulverization, mechanical pulverization or other pulverization techniques understood by one skilled in the art.

The cathode electrode includes a collector current substrate and cathode material disposed about the substrate, the cathode material includes the cathode active material, conductive agents and adhesives, with the cathode collector current substrate being a variety of known collector current substrates including aluminum foil and the cathode active material containing the lithium iron(II) phosphate cathode active materials of the presently disclosed embodiments. The conductive agent can include acetylene black as well as other known conductive agents. If nickel cathodes are used, the adhesive can be a mixture of carboxymethyl cellulose (CMC) and polytetrafluoroethylene (PTFE) or a variety of suitable adhesives. The amount and concentration of collector current substrate, cathode active material, conductive agents and adhesives necessary to form the cathode are known by one skilled in the art and will not be discussed in further detail.

The disclosed battery includes a battery core, electrolyte and battery shell, the battery core and electrolyte being situated within the battery shell. The battery core includes a cathode electrode and an anode electrode with a partition between the two electrodes. The cathode electrode includes the lithium iron(II) phosphate cathode active material in accordance with the presently disclosed embodiments. The electrolyte can be a variety of electrolytes including lithium hexafluorophosphate, ethylene carbonate (EC) and diethyl carbonate (DEC). The battery as provided by the present invention utilizes the cathode active materials for the cathode electrode but does not place restrictions on the anode electrode, partition, separator film, electrolyte or the battery shell. As such, these components can use materials and be manufactured by methods as known by one skilled in the arts.

The following are various embodiments of cathode active materials containing lithium iron(II) phosphate (LiFePO₄) and methods of preparation thereof.

### EXAMPLE 1

Mix 5 moles of lithium carbonate, 10 moles of ferrous oxalate, 0.4 mole of iron powder with average particle sizes of 40 nanometers, 10.2 moles of ammonium dihydrogen phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 2

Mix 5 moles of lithium carbonate, 10 moles of ferrous oxalate, 0.3 mole of iron powder with average particle sizes of 10 nanometers, 10.15 moles of ammonium hydrogen phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 3

Mix 10 moles of lithium acetate dihydrate, 10 moles of ferrous oxalate, 0.4 mole of iron powder with average particle sizes of 40 nanometers, 10.2 moles of ammonium hydrogen phosphate, 0.5 mole of sucrose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 4

Mix 10 moles of lithium hydroxide, 10 moles of ferrous oxalate, 0.4 mole of iron powder with average particle sizes of 40 nanometers, 10.2 moles of ammonium hydrogen phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 8 hours while the sintering process can occur at about 800° C. for 15 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 5

Mix 10 moles of lithium nitrate, 10 moles of ferrous carbonate, 0.4 mole of iron powder with average particle sizes of 40 nanometers, 10.2 moles of ammonium hydrogen phosphate, 0.5 mole of glucose, 0.5 mole of sucrose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 6

Mix 5 moles of lithium carbonate, 10 moles of ferrous acetate, 0.8 mole of iron powder with average particle sizes of 50 nanometers, 10.5 moles of ammonium hydrogen phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 7

Mix 5 moles of lithium carbonate, 10 moles of ferrous oxalate, 0.3 mole of iron powder with average particle sizes of 10 nanometers, 10.15 moles of ammonium hydrogen phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 700° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 8

Mix 5 moles of lithium hydroxide, 10 moles of ferrous oxalate, 0.6 mole of iron powder with average particle sizes of 25 nanometers, 10.32 moles of ammonium hydrogen phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 8 hours while the sintering process can occur at about 800° C. for 15 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 9

Mix 5 moles of lithium carbonate, 10 moles of ferrous oxalate, 0.4 mole of iron powder with average particle sizes of 40 nanometers, 10 moles of triammonium phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### EXAMPLE 10

Mix 5 moles of lithium oxalate, 10 moles of ferrous oxalate, 0.4 mole of iron powder with average particle sizes of 40 nanometers, 5 moles of ammonium dihydrogen phosphate, 5 moles of diammonium phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### REFERENCE 1

Mix 5 moles of lithium carbonate, 10 moles of ferrous oxalate, 10.2 moles of ammonium dihydrogen phosphate, 1.5 moles of glucose, and 4 kilograms of acetone in a ball mill, grind for 10 hours and remove the uniform mixture. Place the mixture into a centrifuge to separate and reclaim the acetone. The mixture can subsequently be placed on a plate for pre-sintering and sintering in a high-temperature kiln under nitrogen atmosphere. At a heating rate of 5° C. per minute, the pre-sintering process can occur at about 450° C. for 6 hours while the sintering process can occur at about 750° C. for 20 hours. Next, at a cooling rate of 5° C. per minute, the mixture can be cooled to room temperature and removed from the kiln. The mixture is then subjected to air current pulverization to provide lithium iron(II) phosphate cathode active particles with an average diameter of 2 microns with 15 microns maximum.

### Analysis of Examples 1-3 and Reference 1

### Examples 1-3

### Formational and Compositional Analyses of the Lithium Iron(II) Phosphate Cathode Active Materials of Examples 1-3

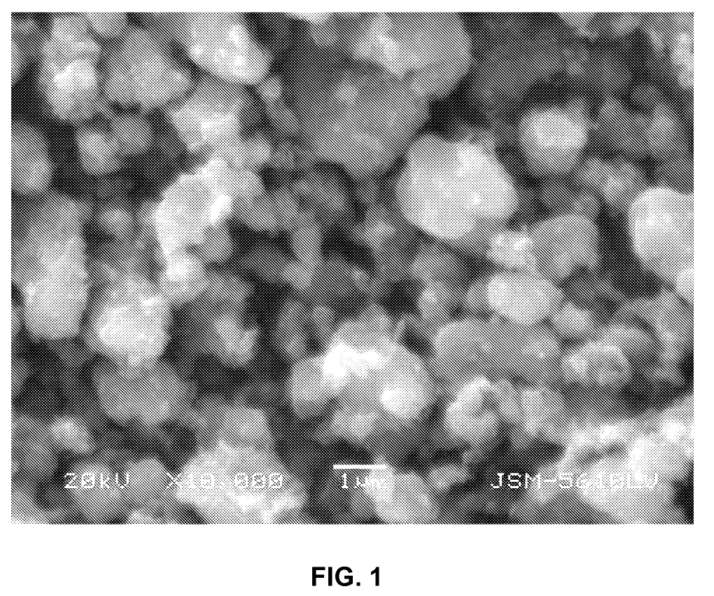

A scanning electron microscope (SEM) image of the lithium iron(II) phosphate cathode active material of Example 1 was performed on a Shimadzu SSX-550 as shown in FIG. 1.

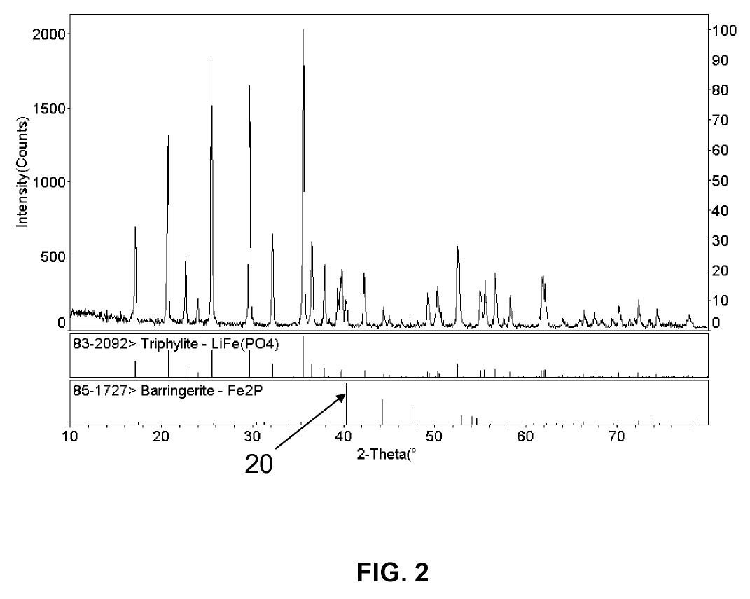

Reference is now made to FIG. 2 showing an x-ray diffraction (XRD) pattern of Example 1 as carried out on a Rigaku D/MAX-2200/PC with the lithium iron(II) phosphate having a standard olivine structure, and a characteristic iron phosphide peak at 2-Theta(Θ) of about 40.02 as indicated by numeral 20.

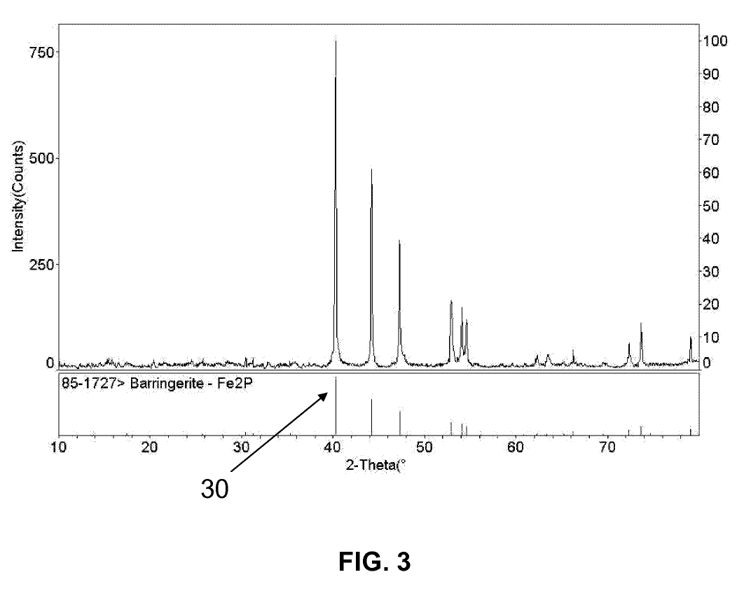

Reference is now made to FIG. 3 showing the XRD pattern of Example 1 after the lithium iron(II) phosphate cathode active material has been dissolved in 15% hydrochloric acid to produce an insoluble substance. As shown by the figure, the insoluble substance of Example 1 includes mostly amorphous carbon and iron phosphide, as demonstrated by the similar characteristic peak at 2-Theta(Θ) of about 40.02 as indicated by numeral 30.

Using a high frequency infrared carbon-sulfur analytical instrument model HW2000B from the WuXi Yingzhicheng High Speed Analytical Instrument Co., Ltd., the carbon contents of Examples 1-3 and the carbon contents of the insoluble substances of Examples 1-3 dissolved in 15% hydrochloric acid were tested and recorded as shown below in Table 1.

As listed in Table 1, the total carbon content of the lithium iron(II) phosphate produced by Example 1 was approximately 2.14%. After being dissolved in hydrochloric acid, the carbon content of the insoluble substance was about 55.73%. According to the XRD of FIG. 3, the remaining composition was mostly iron phosphide, which has a total content of not more than 44.27% of the insoluble substance (100% minus 55.73%). Based on the carbon content of the lithium iron(II) phosphate carbon active material, the total content of the iron phosphide within the material can be extrapolated at about 1.70%. Similarly, the total iron phosphide content of the lithium iron(II) phosphates produced by Examples 2 and 3 are 1.90% and 2.03%, respectively, as shown in Table 1.

Using a Physical Electronics PHI 5800x-ray photoelectron spectrometer, the contents of various elements on the surfaces of the lithium iron(II) phosphate cathode active materials of Examples 1-3 were determined. Based on these values and the total iron phosphide contents, the amount of iron phosphide disposed about the surfaces of the lithium iron(II) phosphate cathode active materials relative to the total iron phosphide content (%) were also determined and recorded in Table 1.

### Reference 1

### Formational and Compositional Analyses of the Lithium Iron(II) Phosphate Cathode Active Material of Reference 1

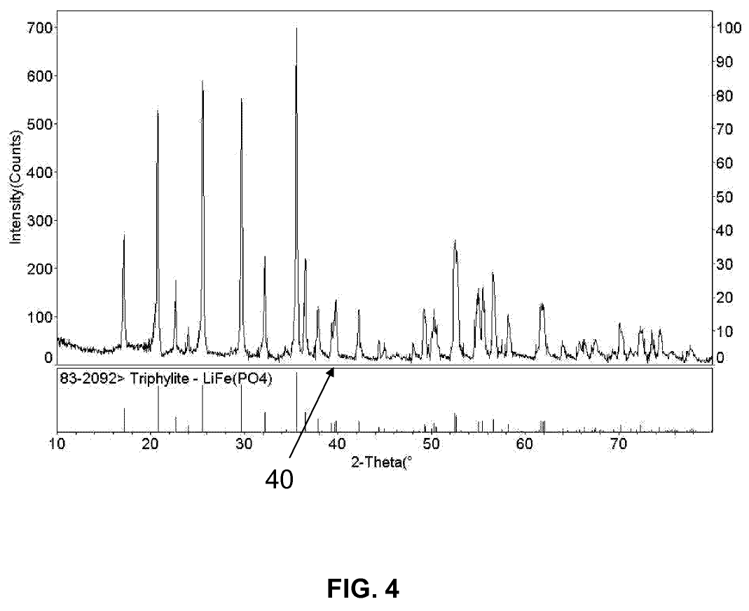

Reference is now made to FIG. 4 showing an x-ray diffraction (XRD) pattern of Reference 1 as carried out on a Rigaku D/MAX-2200/PC with the lithium iron(II) phosphate having a standard olivine structure, but without the characteristic iron phosphide peak at 2-Theta(Θ) of about 40.02 as indicated by numeral 40.

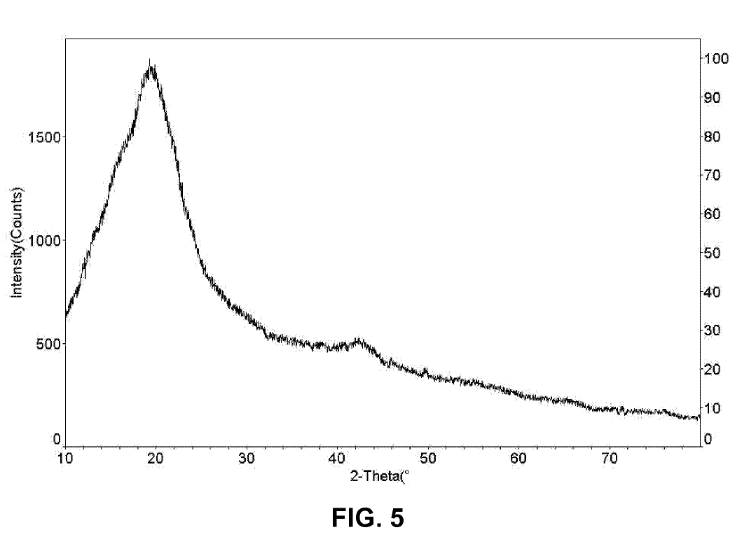

In addition, FIG. 5 shows the XRD pattern of Reference 1 after the lithium iron(II) phosphate cathode active material was dissolved in 15% hydrochloric acid to produce an insoluble substance. As shown in the figure, the insoluble substance of Reference 1 is mostly amorphous carbon.

Using a high frequency infrared carbon-sulfur analytical instrument model HW2000B from the WuXi Yingzhicheng High Speed Analytical Instrument Co., Ltd., the carbon content of Reference 1 and the carbon content of the insoluble substance of Reference 1 dissolved in 15% hydrochloric acid were tested and recorded as shown in Table 1.

Likewise, using a Physical Electronics PHI 5800x-ray photoelectron spectrometer, the contents of various elements on the surface of the lithium iron(II) phosphate cathode active material of Reference 1 were determined. Based on these values and the total iron phosphide content, the amount of iron phosphide disposed about the surface of the lithium iron(II) phosphate cathode active material of Reference relative to the total iron phosphide content (%) was also determined as shown in Table 1.

TABLE 1
Analytical results of Examples 1-3 and Reference 1.

| | | Amount of iron | |
|---|---|---|---|
| | | phosphide disposed | |
| | Total | about the surface | |
| | iron | of the lithium iron(II) | Total |
| | phosphide | phosphate relative | carbon |
| | content | to the total iron | content |
| Sample | (weight %) | phosphide content (%) | (weight %) |
| Example 1 | 1.70 | 80 | 2.14 |
| Example 2 | 1.90 | 68 | 2.46 |
| Example 3 | 2.03 | 50 | 1.79 |
| Reference 1 | 0 | 0 | 2.42 |
| Insoluble substance | — | — | 55.73 |
| of Example 1 | | | |
| Insoluble substance | — | — | 56.42 |
| of Example 2 | | | |
| Insoluble substance | — | — | 46.87 |
| of Example 3 | | | |
| Insoluble substance | — | — | 99.98 |
| of Reference 1 | | | |

As shown in Table 1, the lithium iron(II) phosphate of Example 1 has a carbon content of 2.14%. After it has been dissolved in hydrochloric acid, the insoluble substance has a carbon content of 55.73%. In contrast, the lithium iron(II) phosphate sample of Reference 1 has a carbon content of 2.42%. After it has been dissolved in hydrochloric acid, the insoluble substance has a carbon content of 99.98%, an indication that the samples as produced by Reference 1 is mostly lithium iron(II) phosphate and amorphous carbon.

### Testing of Examples 1-10 and Reference 1

### Determination of the Electrochemical Properties of the Lithium Iron(II) Phosphate Cathode Active Materials of Examples 1-10 and Reference 1

Separately using each of the lithium iron(II) phosphate of Examples 1-10 and Reference 1 as the cathode active material, mix each cathode active material with acetylene black, polyvinylidene fluoride, and N-methyl-2-pyrrolidone in a ratio of 85:10:5:90 to form a slurry. Place the slurry on a single side of a 1000 mm×200 mm×16 micron aluminum foil. Dry, compress and punch the foil to form a 16 mm wafer of cathode film. There should be about 0.08 g of cathode active material on each cathode film. Accordingly, a battery core can be assembled using the cathode film as the cathode electrode and a lithium chip or graphite as the anode electrode. Between a potential range of 2.5 to 3.85 V and at current capacity of 15 mAh/g, the charge/discharge testing and the electrochemical properties of the Examples of 1-10 and Reference 1 are recorded as shown in Table 2.

TABLE 2
Results of the electrical testing of Examples 1-10 and Reference 1.

| | | Discharge | Discharge |
|---|---|---|---|
| | | capacity | maintenance rate |
| Source of cathode | Initial discharge | after 20 cycles | after 20 cycles |
| active material | capacity (mAh/g) | (mAh/g) | (mAh/g) |
| Example 1 | 140.9 | 139.1 | 98.7 |
| Example 2 | 142.6 | 139.9 | 98.1 |
| Example 3 | 140.0 | 135.7 | 96.9 |
| Example 4 | 136.7 | 135.3 | 99.0 |
| Example 5 | 139.7 | 135.1 | 96.7 |
| Example 6 | 141.5 | 134.7 | 95.2 |
| Example 7 | 144.0 | 139.4 | 96.8 |
| Example 8 | 139.3 | 134.7 | 96.7 |
| Example 9 | 139.8 | 136.4 | 97.6 |
| Example 10 | 137.9 | 134.2 | 97.3 |
| Reference 1 | 128.9 | 119.2 | 92.5 |

Based on the data in Table 2 and because of the addition of the nano-size iron particles in forming iron phosphide, the charge-discharge capacities of Examples 1-10 are substantially higher than that of Reference 1. Specifically, Examples 1-10 having lithium iron(II) phosphate and iron phosphide have, on average, about 11 mAh/g higher charge-discharge capacity than Reference 1, which consists of mostly lithium iron(II) phosphate and amorphous carbon. After 20 cycles, Reference 1 exhibited considerable drop in the discharge capacity with the ability to maintain the rate of discharge at only 92.5%. In contrast, the cathode active material of Example 1 still has the ability to maintain a discharge rate of 98.7% after 20 cycles.

Although the invention has been described in detail with reference to several embodiments, additional variations and modifications exist within the scope and spirit of the invention as described and defined in the following claims.

What is claimed is:

1. A lithium iron(II) phosphate cathode active material comprising:
lithium iron(II) phosphate particles;
nano-carbon particles; and
iron phosphide, wherein a first portion of the iron phosphide can be disposed about the surfaces of the lithium iron(II) phosphate particles.

2. The material of claim 1, wherein the first portion of the iron phosphide is about 50 to 80% of the total weight of the iron phosphide in the material.

3. The material of claim 1, wherein the lithium iron(II) phosphate particles, iron phosphide and nano-carbon particles have molar ratios of 1:(0.001-0.033):(0.066-0.657).

4. The material of claim 1, wherein the lithium iron(II) phosphate particles have an average particle diameter D50 of about 1 to 7 microns.

5. The material of claim 1, wherein the nano-carbon particles have an average particle diameter D50 of about 1 to 100 nanometers.

6. A method of manufacturing a lithium iron(II) phosphate cathode active material under an inert atmosphere, the method comprising:
providing a mixture having one or more lithium compounds, iron(II) compounds, organic carbon, phosphorous and nano-iron particles;
heating the mixture at a pre-sintering temperature of about 400 to 500° C. for about 6 to 10 hours; and
heating the mixture at a sintering temperature of about 650 to 850° C. for about 8 to 30 hours.

7. The method of claim 6, wherein the mixture has molar ratios of Li:Fe²⁺: Fe:P:C of about 1:(0.9-1.08):(0.01-0.15):(0.9-1.1):(0.1-0.15).

8. The method of claim 6, further comprising adding the mixture to a dispersant prior to the heating steps, the dispersant being one or more of acetone, ethanol and methanol.

9. The method of claim 8, wherein the amount of dispersant is about 0.5 to 3 times the total weight of the lithium compounds, iron(II) compounds, organic carbon, phosphorous and nano-iron particles within the mixture.

10. The method of claim 8, further comprising reclaiming the dispersant by centrifuge or filtration prior to the heating steps.

11. The method of claim 6, wherein the nano-iron particles have an average diameter D50 of about 10 to 50 nanometers.

12. The method of claim 6, wherein the lithium compounds include one or more of lithium carbonate, lithium hydroxide, lithium acid, lithium nitrate and lithium oxalate; the iron(II) compounds include one or more of ferrous oxalate, ferrous chloride and ferrous acid; the phosphorous includes one or more of ammonium phosphate, ammonium hydrogen phosphate and ammonium dihydrogen phosphate; and the organic carbon includes one or more of glucose, sucrose, citric acid, polyvinyl alcohol, polyethylene glycol and starch.

13. A lithium-ion battery comprising:
a battery core;
electrolyte; and
a battery shell, wherein the battery core and electrolyte are situated within the battery shell, and wherein the battery core includes a cathode electrode, an anode electrode, and a partition between the two electrodes, the cathode electrode having a cathode material comprising:
a lithium iron(II) phosphate active material, the active material comprising:
lithium iron(II) phosphate particles;
nano-carbon particles; and
iron phosphide, wherein a first portion of the iron phosphide can be disposed about the surfaces of the lithium iron(II) phosphate particles.

14. The battery of claim 13, wherein the first portion of the iron phosphide is about 50 to 80% of the total weight of the iron phosphide in the material.

15. The battery of claim 13, wherein the lithium iron(II) phosphate particles, iron phosphide and nano-carbon particles have molar ratios of 1:(0.001-0.033):(0.066-0.657).

16. The battery of claim 13, wherein the lithium iron(II) phosphate particles have an average particle diameter D50 of about 1 to 7 microns.

17. The battery of claim 13, wherein the nano-carbon particles have an average particle diameter D50 of about 1 to 100 nanometers.
